(19) United States
(12) Patent Application Publication
(10) Pub. No.: US 2022/0272997 A1
(43) Pub. Date: Sep. 1, 2022

(54) METHOD AND DEVICE FOR DISPENSING A BEVERAGE ENRICHED WITH A GAS FROM A GAS PRESSURE VESSEL

(71) Applicant: Franke Kaffeemaschinen AG, Aarburg (CH)

(72) Inventor: Simon MUELLER, Muhen (CH)

(73) Assignee: Franke Kaffeemaschinen AG, Aarburg (CH)

(21) Appl. No.: 17/625,914

(22) PCT Filed: Jul. 7, 2020
(86) PCT No.: PCT/EP2020/069055

§ 371 Date: Jan. 10, 2022

(30) Foreign Application Priority Data
Jul. 10, 2019 (EP) 19185612.9

(51) Int. Cl. A23F 5/24; A47J 31/00; A47J 31/46; B01F 23/232; B01F 23/237; B01F 25/4314; B01F 35/71

(52) U.S. Cl. CPC A23F 5/243; A47J 31/002; A47J 31/468; A47J 31/467; B01F 23/232; B01F 23/23765; B01F 25/4314; B01F 35/71805; B67D 1/1275

(57) ABSTRACT

In a method for dispensing a beverage in which a gas from a gas pressure vessel in which the gas is stored under pressure is mixed with the beverage, it is provided that the beverage is transported out of the storage container (2) by a pump (3) and that the pressure of the gas is lowered to less than 0.5 bar, more preferably less than 100 mbar, above ambient pressure and is fed to the aspirated beverage on the suction side of the pump (3).

### TECHNICAL FIELD

The present invention relates to a method for dispensing a beverage, in which a gas from a gas pressure vessel in which the gas is stored under pressure is mixed with the beverage. The invention moreover relates to a beverage dispensing device for dispensing a beverage enriched with a gas at a beverage outlet, wherein the device has a high-pressure connection for connection of a gas pressure vessel in which the gas is stored under pressure.

### BACKGROUND

Alongside classic, freshly brewed coffee beverages such as espresso, cappuccino, or filter coffee, coffee beverages based on a supplied ready-to-drink beverage or a concentrate have recently increasingly been offered for sale. These include in particular so-called cold-brew coffee which is steeped with cold water for several hours and enjoyed cold. In a particular variant, such a cold coffee beverage is mixed with nitrogen when dispensed. A rich head of froth and a thick, creamy mouth feel result, similar to a stout enriched with nitrogen (Guinness). This kind of coffee beverage has become known in the market as nitro cold-brew coffee.

According to the method which is currently practiced, nitrogen from a high-pressure gas canister is injected into the coffee beverage when it is dispensed by means of a kind of tap. The tap equipment used to do this is made available as individual pieces of equipment and has to be supplied and set up additionally at the sales points. This is costly and takes up a lot of space. Integration into existing fully automatic coffee machines for the catering sector is not possible or envisaged here.

A manual tap as is typically used in British pubs is described in GB 2 129 775 A. In the case of the tap shown there, beer is delivered via a manual piston pump, wherein air is fed to the beer on the suction side of the piston pump by means of an air valve. The sucked-in beer/air mixture is frothed with the aid of a frothing disk in the tap.

U.S. Pat. No. 10,182,587 B2 describes a dispensing unit in which beverages including cold coffee beverages can be delivered by means of gas pressure and optionally enriched or infused with gas. The enrichment with gas takes place in a frothing chamber in which the beverage delivered under pressure is sprayed via an atomizer.

### SUMMARY

The object of the invention is therefore to provide an alternative, simplified method and a corresponding device for dispensing beverages enriched with gas from a gas pressure vessel which in particular makes it possible to dispense them at conventional fully automatic coffee machines or such machines equipped for this purpose.

The object is achieved with regard to the method by the use of one or more of the features described herein and with regard to the device by one or more of the features described herein. Advantageous embodiments can be found below and in the claims.

In the case of a method for dispensing a beverage, in which a gas from a gas pressure vessel in which the gas is stored under pressure is mixed with the beverage, it is provided according to the invention that the beverage is delivered from a storage vessel by a pump, and that the pressure of the gas is reduced to close to the ambient pressure, in particular less than 0.5 bar, more preferably less than 100 mbar, and most preferably less than 50 mbar above the ambient pressure, and is fed, at the suction side of the pump, to the sucked-in beverage. The beverage can in particular be a coffee beverage. The said method can, however, also be applied for other beverages such as, for example, a tea beverage.

The gas is thus introduced into the coffee beverage upstream from the pump with essentially no pressure. The gas and the ready-to-drink beverage are mixed essentially inside the pump. Nitrogen can in particular be used as the gas which imparts a pleasantly creamy taste and pleasantly creamy mouth feel to the beverage, in particular a coffee beverage.

In this way, a coffee beverage enriched with gas can be dispensed using only a pump from the ready-to-drink beverage or concentrate supplied in the storage vessel. The modules required can be accommodated simply and in a space-saving fashion in an existing appliance such as, for example, a fully automatic coffee machine or a refrigerator provided for cooling the ready-to-drink beverage. The refrigerator can equally be used for other supplements such as, for example, milk, cream, crushed ice, or the like. In this way, an integrated beverage dispensing device can be created.

It is provided in particular within the context of the present invention that the coffee beverage is a cold-brew coffee. In order to prepare it, ground coffee is steeped in cold water for several hours or the cold water is filtered very slowly through ground coffee for several hours using a so-called cold water dripper. This cold-brew coffee has a very intense flavor, is very palatable, and, in contrast to hot brewed coffee, is a very good alternative when the weather is hot.

The storage vessel can additionally be cooled such that the coffee beverage is dispensed as a cold beverage.

It is of course also possible to heat the coffee beverage when it is dispensed, for example by a thermoblock arranged downstream from the pump in the direction of flow.

If the coffee beverage is dispensed as a cold beverage, ice can additionally be added to the coffee beverage when it is dispensed. If the ready-to-drink beverage is supplied in concentrated form, water can additionally be added when it is dispensed. This can happen either upstream or downstream from the pump. Likewise, the water can be added separately at the beverage outlet. The adding of other beverage additives such as, for example, syrup, sherry, or liqueur, frothed milk, or the like is also conceivable.

It is provided in a preferred embodiment that the beverage enriched with gas is delivered to a beverage outlet by a counterpressure element arranged downstream from the pump in the delivery direction. The counterpressure element is a flow resistance against which the pump has to pump the sucked-in mixture of coffee beverage and air such that there is an elevated pressure at the outlet of the pump. This elevated pressure results in an even greater mixing of the mixture of coffee beverage and air in the pump and hence in a creamy and frothy consistency of the coffee beverage.

A geared pump can be considered in particular. It has been proved that thus type of pump yields the best deliciously creamy and frothy consistency. This may be due to particularly thorough mixing of the air/beverage mixture by the gear wheels of the pump.

Either a constriction, i.e. a narrowed cross-section and subsequent widened section such as, for example, an orifice plate or a restrictor, can be used as the counterpressure element or alternatively it can be formed by a simple pressure hose with a reduced internal cross-section. However, the use of a mixer, in particular a spiral mixer, with no narrowed cross-section but which acts a flow resistor by changing the direction multiple times is preferred within the scope of the invention. Such a mixer moreover causes the stream of liquid enriched with gas to be split up and merged many times in multiple partial streams such that further mixing and enhancement of the creamy coffee/air mixture is obtained. A further form of flow resistor suitable within the scope of the invention is a so-called resistance passage element which is formed by a plurality of flow paths branching out in a labyrinth-like fashion and likewise causes the stream of fluid to be split up many times into partial streams, merged, and split up again.

In a further preferred embodiment, the fed-in amount of gas can be metered by a gas metering valve. A simple needle valve, by which the amount of air can be metered by adjusting the suction opening, can be used, for example, as the gas metering valve. However, a timed shut-off valve, possibly combined with a fixed orifice plate and which opens and closes in quick succession and hence frees and recloses the suction opening, is preferably used within the scope of the present invention. In this case, the duty cycle, i.e. the ratio between the time open and the repetition interval, can be modified for the purpose of metering. The gas metering valve is thus opened on average for a shorter or longer duration in order to add in less or more air, respectively. The consistency of the dispensed coffee beverage can in particular also be modified via the amount of air.

In a beverage dispensing device according to the invention which is designed to dispense a beverage enriched with a gas at a beverage outlet and has a high-pressure connection for connecting a gas pressure vessel in which the gas is stored under pressure, according to the invention a pump is provided for delivering the beverage to the beverage outlet via a suction line from the storage vessel, as well as a pressure relief device connected on the input side to the high-pressure connection and which is designed to reduce the pressure of the gas to a pressure close to the ambient pressure, in particular less than 0.5 bar, more preferably less than 100 mbar, most preferably less than 50 mbar above the ambient pressure, and which is connected on the output side to a gas feed line which opens into the suction line in order to feed in the gas at a reduced pressure to the sucked-in beverage at the suction side of the pump.

A counterpressure element, by which the beverage enriched with gas is delivered to the beverage outlet, is preferably arranged downstream from the pump in the delivery direction. A restrictor or a static mixer, in particular a spiral mixer, can preferably be used as the counterpressure element. A geared pump is preferably used as the pump.

Furthermore, in a preferred embodiment, a gas metering valve, in particular a timed shut-off valve, is arranged in the gas feed line for metering the flow rate of the gas fed to the coffee beverage.

### BRIEF DESCRIPTION OF THE DRAWINGS

Further advantages and properties of the invention emerge from the following description of an exemplary embodiment with the aid of the drawings, in which:

FIG. 1 shows a water flow diagram of a device for dispensing a coffee beverage enriched with gas, and

FIG. 2 shows a partially cutaway isometric illustration of a counterpressure element, in the form of a spiral mixer, used in the exemplary embodiment.

### DETAILED DESCRIPTION

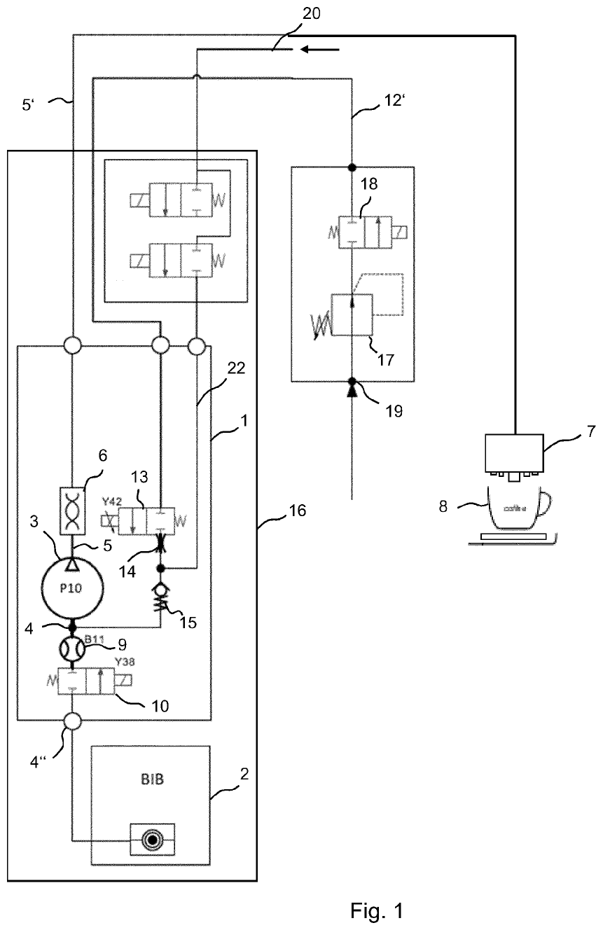

The device illustrated in FIG. 1 in the form of a water flow diagram comprises a storage vessel 2 with a cold-brew coffee beverage, an electric pump 3 which is connected to the storage vessel 2 on the suction side via a suction line 4, and a counterpressure element 6, in the form of a spiral mixer, attached to the discharge side of the pump 3. The outlet line 5′ leads from the spiral mixer 6 to a beverage outlet 7 at which the cold-brew coffee beverage enriched with gas is dispensed into a drinking vessel 8 positioned below it. The beverage outlet can here be integrated into the outlet head of a fully automatic coffee machine such that the coffee beverage enriched or frothed with gas can be dispensed as a further beverage option by the fully automatic coffee machine.

A flow meter 9, by which the amount of beverage can be metered, and a shut-off valve 10 which is opened at the beginning of the beverage preparation and is closed once the beverage preparation is complete in order to prevent fluid still situated in the line 4 from flowing back, are situated in the suction line 4. A gas feed line 12 opens into the suction line 4. A gas metering valve 13, a fixed orifice plate 14, and a non-return valve 15 are situated in the gas feed line 12. In the exemplary embodiment, the gas metering valve 13 is configured as a timed air valve, i.e. as a switching valve which intermittently opens and closes in quick succession. The frequency at which the air valve operates can here lie within the range of 10 and 30 Hz. The non-return valve 15 serves only to restrict or prevent liquid from penetrating the air feed line.

The pump 3, the counterpressure element 6, the flow meter 9 and the gas metering valve 13 are combined to form a pump module or a pump assembly 1. This furthermore comprises the shut-off valve 10 in the feed line 4 and also the non-return valve 15 and the orifice plate 14 in the gas feed line 12.

The pump module 1 and the storage vessel 2 are arranged in a refrigerator 16. The storage vessel 2 is here designed as a disposable vessel with a pouch situated in a cardboard box (bag in box, BiB, packaging). A pressure relief device 17 and a shut-off valve 18 are connected outside the refrigerator 16 to the gas feed line 12′ leading to the pump module 1. A gas pressure vessel (not shown here), for example a conventional gas canister at approximately 200 bar gas pressure, can be connected on the input side via the pressure relief device 17. The pressure relief device 17 is configured or set in the exemplary embodiment such that it reduces the pressurized gas at the input to an output pressure of just 50 mbar at which the gas is fed into the feed line 4 at the output side of the pump. At the pressure relief device (or pressure-reducing valve), the output pressure is fed as a control input and ensures, by a pressure transducer, that a pressure valve blocks flow when the predetermined target output pressure is exceeded and opens when the pressure falls below it. The output pressure thus cannot rise above this pre-set value. A piston or a diaphragm can here serve as a pressure transducer.

Lastly, a flushing connection 20, which opens into the gas feed line 12 upstream from the non-return valve 15 via a shut-off valve 21 and a flushing line 22, is shown in the exemplary embodiment. After a product has been prepared, a flushing process with cold or warm water can be performed via this flushing line 22. For this purpose, the valve 10 is closed at the product input, the valve 21 is opened at the flushing water inflow 20, and the pump 3 is set in operation. A collecting vessel is placed below the beverage outlet 7 in order to collect the flushing water. The flushing process serves in particular to flush the non-return valve 15 so that it cannot clog up and jam. A further flushing valve 21′ connected in parallel in the exemplary embodiment to the valve 21 is provided optionally to connect a further pump module (not shown here), which is optionally housed in the refrigerator 16, to the flushing connection 20.

In order to dispense a frothed cold-brew coffee beverage, the valve 10 is opened at the product input 4′ and the pump 3 is set in operation. A ready-made beverage stored in the storage vessel 2 is sucked in therefrom and delivered to the beverage outlet 7 via the spiral mixer 6.

At the same time, the shut-off valve 18 at the gas inlet is opened and nitrogen from the gas pressure vessel connected to the gas connection 19 flows via the gas metering valve 13 by which the amount of gas fed in can be metered, the orifice plate 14, and the non-return valve 15 to the gas feed line 12 which opens into the suction line 4. The pump 3 thus sucks in gas from the gas connection 19 in addition to ready-to-drink beverage from the storage vessel 2. By virtue of the spiral mixer 6, a high pressure is generated at the pump output or in the pump 3. This results in mixing of the air/beverage mixture in the pump and in this way generates a creamy and frothy fluid, enriched with gas, which is dispensed at the beverage outlet 7.

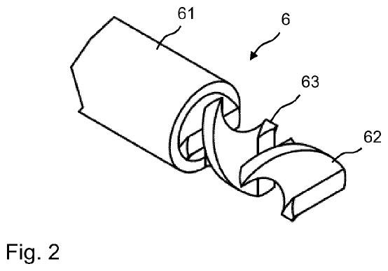

A spiral mixer 6, employed as a counterpressure element in FIG. 1, is illustrated in FIG. 2. A spiral mixer is a so-called static mixer in which a plurality of spirals 62, 63, offset relative to one another in each case by 90° and arranged one behind the other, are arranged in a tubular housing 61. The successive spirals moreover each have an opposite direction of rotation. Each spiral splits the stream of flowing liquid into two partial streams. These are in turn split into partial streams at each transition to the respective following spiral and in each case merged with partial streams from the preceding spiral. In this way, the stream of liquid is mixed. The spiral mixer moreover represents a largely laminar flow resistance without there being any need here for the flow cross-section to be reduced. The housing 61 of the mixer 6 is shown in FIG. 2 in a partially cut-away view so that the spiral sections 62, 63, each offset by 90° and situated inside, can be seen.

1. A method for dispensing a beverage, the method comprising:
mixing a gas from a gas pressure vessel in which the gas is stored under pressure with the beverage,
delivering the beverage from a storage vessel (2) by a pump (3), and
reducing a pressure of the gas is reduced to less than 0.5 above the ambient pressure, and feeding the gas at a suction side of the pump (3), to the beverage drawn in by the pump.

2. The method as claimed in claim 1, wherein the beverage is a cold-brew coffee.

3. The method as claimed in claim 1, further comprising adding at least one of water or ice to the beverage.

4. The method as claimed in claim 1, wherein the gas is nitrogen.

5. The method as claimed in claim 1, wherein the beverage is stored in a storage vessel (2) as a beverage concentrate, and the storage vessel (2) is cooled and the beverage is dispensed as a cold beverage.

6. The method as claimed in claim 1, wherein the pump (3) comprises a geared pump.

7. The method as claimed in claim 1, further comprising delivering the beverage enriched with gas to a beverage outlet (7) by a counterpressure element (6) arranged downstream from the pump (3).

8. The method as claimed in claim 7, wherein the counterpressure element (8) comprises a restrictor or a static mixer.

9. The method as claimed in claim 1, further comprising arranging a gas metering valve (13) by which a volume of the gas fed to the beverage is metered in a feed line (12) for the gas fed to the sucked-in beverage.

10. A beverage dispensing device for dispensing a beverage enriched with a gas at a beverage outlet (7), the device comprising:
a high-pressure connection (19) for connecting a gas pressure vessel in which the gas under pressure is stored,
a pump (3) for delivering the beverage to the beverage outlet (7) via a suction line (4) from the storage vessel (2), and
a pressure relief device (17) connected on an input side to the high-pressure connection (19) that is configured to reduce the pressure of the gas to a pressure less than 0.5 bar above ambient pressure, and which is connected on an output side to a gas feed line (12, 12′) which opens into the suction line (4) in order to feed in the gas at a reduced pressure to the sucked-in beverage at a suction side of the pump (3).

11. The beverage dispensing device as claimed in claim 10, further comprising a counterpressure element (6), by which the beverage enriched with gas adapted to be is delivered to the beverage outlet (7), arranged downstream from the pump (3) in a delivery direction.

12. The beverage dispensing device as claimed in claim 11, wherein the counterpressure element (6) comprises a restrictor or a static mixer.

13. The beverage dispensing device as claimed in claim 10, wherein the pump comprises a geared pump.

14. The beverage dispensing device as claimed in claim 10, further comprising a gas metering valve (13) arranged in the gas feed line (12) that is configured for metering a volume of the gas fed to the beverage.

15. The beverage dispensing device as claimed in claim 14, wherein the gas metering valve is a timed shut-off valve.

16. The method of claim 3, wherein the beverage is stored in a storage vessel (2) as a beverage concentrate, and the water is added to the beverage concentrate upstream or downstream from the pump.

17. The method of claim 8, wherein the static mixer is a spiral mixer.
